(19) United States
(12) Patent Application Publication
(10) Pub. No.: US 2010/0171617 A1
(43) Pub. Date: Jul. 8, 2010

(54) WIRELESS TAG READING METHOD AND APPARATUS

(75) Inventor: Kouichi Sano, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/638,141

(22) Filed: Dec. 15, 2009

(30) Foreign Application Priority Data
Jan. 6, 2009 (JP) 2009-000996

(51) Int. Cl. G08B 13/22; G06K 7/01

(52) U.S. Cl. 340/572.1; 340/10.1

(57) ABSTRACT

A method of reading, by a wireless tag reading apparatus, article wireless tags attached to articles placed in a reading area, the method includes, disposing an outside-area distinguishing wireless tag differentiable from the article wireless tag outside the boundary of the reading area, transmitting an electromagnetic signal to the reading area from an antenna of the wireless tag reading apparatus to read the wireless tags, searching the read wireless tags to find out whether the outside-area distinguishing wireless tag is included therein, and determining that the reading range is greater than the reading area if the outside-area distinguishing wireless tag is included in the read wireless tags.

### CROSS-REFERENCE TO RELATED APPLICATION

This application is based upon and claims the benefit of priority from the prior Japanese Patent Application No. 2009-000996, filed Jan. 6, 2009, the entire contents of which are incorporated herein by reference.

### TECHNICAL FIELD

The present invention relates to a method and an apparatus for reading a wireless tag attached to an item of merchandise in a reading area by use of an electromagnetic signal.

### BACKGROUND

Jpn. Pat. Appln. KOKAI Publication No. 2002-271229 discloses a method of detecting, by means of an electromagnetic signal, a desired item of merchandise from a group of items of merchandise to which wireless tags are attached. A wireless tag reading apparatus changes the direction of emission of an electromagnetic signal transmitted from an antenna in order to read the wireless tags attached to the antennas. The wireless tag reading apparatus previously stores data for the wireless tag attached a desired item of merchandise. The wireless tag reading apparatus compares the data read from the wireless tag with the stored data to detect the desired item of merchandise.

The method described in the above-mentioned publication is effective when a desired item of merchandise can be identified in advance. However, this method is not applicable to the case where the item of merchandise placed in a wireless tag reading area cannot be identified.

The reason is that an electromagnetic signal transmitted from the antenna of the wireless tag reading apparatus to the reading area does not necessarily remain within the reading area. In order for the wireless tag reading apparatus to only use the inside of the reading area as the area for communicating with the wireless tag, the reading area has to be surrounded by a mask that does not transmit the electromagnetic signal. If the reading area is not surrounded by the mask, the electromagnetic signal reaches the outside of the reading area. Therefore, even if a wireless tag of an item of merchandise placed outside the boundary of the reading area is included in the wireless tags read by the wireless tag reading apparatus, it is difficult for a user to know whether this wireless tag is the wireless tag attached to the item of merchandise outside the reading area.

### SUMMARY

An object of the present invention is to accurately read only the article wireless tag of an article placed in a reading area without surrounding the reading area by a mask that does not transmit electromagnetic signal.

According to one aspect of the present invention, a method of reading, by a wireless tag reading apparatus, article wireless tags attached to articles placed in a reading area, the method includes, disposing an outside-area distinguishing wireless tag differentiable from the article wireless tag outside the boundary of the reading area, transmitting an electromagnetic signal to the reading area from an antenna of the wireless tag reading apparatus to read the wireless tags, searching the read wireless tags to find out whether the outside-area distinguishing wireless tag is included therein, and determining that the reading range is greater than the reading area if the outside-area distinguishing wireless tag is included in the read wireless tags.

According to one aspect of the present invention, an apparatus which reads article wireless tags attached to articles, the apparatus includes, an antenna which transmits an electromagnetic signal to a reading area for the article wireless tag, an output varying unit which changes the transmission output of the electromagnetic signal transmitted from the antenna, a read trial unit which changes the transmission output of the electromagnetic signal to repeat the reading of the article wireless tag, a search unit which searches the read wireless tags to find out whether an outside-area distinguishing wireless tag is included therein whenever the article wireless tag is read by the read trial unit, the outside-area distinguishing wireless tag being disposed outside the boundary of the reading area and being differentiable from the article wireless tag, and a determination unit which determines, as information read from the article wireless tag in the reading area, information read if the outside-area distinguishing wireless tag is not included in the read wireless tags and the transmission output of the electromagnetic signal is maximum.

Additional objects and advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of the entire configuration in a first embodiment according to the present invention;

FIG. 2 is a diagram showing the structures of data stored in an article wireless tag and an outside-area distinguishing wireless tag in the first embodiment;

FIG. 3 is a block diagram showing the configuration of the essential parts of a reading apparatus main body in the first embodiment;

FIG. 4 is a diagram showing a main memory area formed in a storage unit of the reading apparatus main body in the first embodiment;

FIG. 5 is a flowchart showing the procedure of main processing to be executed by a control unit of the reading apparatus main body in the first embodiment;

FIG. 6 is a flowchart showing the procedure of output decrease determination processing to be executed by the control unit of the reading apparatus main body in the first embodiment;

FIG. 7 is a flowchart showing the procedure of output increase determination processing to be executed by the control unit of the reading apparatus main body in the first embodiment;

FIG. 8 is a diagram of the entire configuration in a second embodiment according to the present invention;

FIG. 9 is a diagram showing the structures of data stored in an article wireless tag, an outside-area distinguishing wireless tag and an inside-area distinguishing wireless tag in the second embodiment;

FIG. 10 is a flowchart showing the procedure of main processing to be executed by a control unit of the reading apparatus main body in the second embodiment;

FIG. 11 is a block diagram showing the configuration of the essential parts of a reading apparatus main body in a third embodiment according to the present invention;

FIG. 12 is a flowchart showing the procedure of warning tag update processing to be executed by a control unit of the reading apparatus main body in the third embodiment;

FIG. 13 is a block diagram showing the configuration of the essential parts of a reading apparatus main body in a fourth embodiment according to the present invention;

FIG. 14 is a diagram showing a memory area added to a storage unit of the reading apparatus main body in the fourth embodiment; and

FIG. 15 is a flowchart showing the procedure of main processing to be executed by a control unit of the reading apparatus main body in the fourth embodiment.

### DETAILED DESCRIPTION

Each of the embodiments below assumes a store selling items of merchandise with wireless tags attached thereto. In a checkout lane of this store, a wireless tag reading apparatus according to the present invention is installed. This wireless tag reading apparatus reads the wireless tags attached to the items of merchandise to be purchased by customers, so that sales data for the purchased items of merchandise is registered in a point-of-sales (POS) terminal.

### First Embodiment

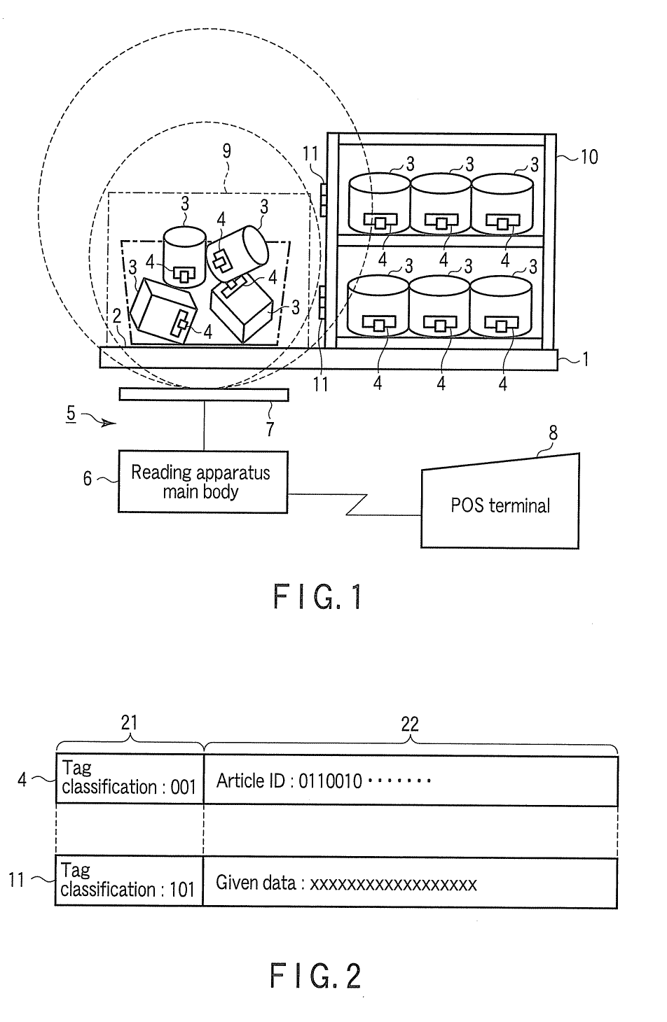

FIG. 1 is a diagram of the entire configuration in a first embodiment. One section of the upper surface of a checkout counter 1 provided along a checkout lane serves as a receiving surface 2 for articles to be purchased. A customer wishing to pay for their purchases places articles 3 to be paid for on the receiving surface 2. The articles 3 may be placed directly on the receiving surface 2, or as shown, may be contained in a shopping basket and thus placed on the receiving surface 2. Wireless tags 4 are attached to the articles 3.

A wireless tag reading apparatus 5 for contactlessly reading data in the wireless tags 4 by means of an electromagnetic signal is composed of a reading apparatus main body 6 and an antenna 7. The antenna 7 is a planar antenna, and is installed immediately under the receiving surface 2 across the checkout counter 1. Alternatively, the antenna 7 may be attached to the receiving surface 2 of the checkout counter 1 or may be incorporated in the checkout counter 1.

The wireless tag reading apparatus 5 collectively reads the wireless tags 4 of all the articles 3 placed on the receiving surface 2, and sends the read data to a POS terminal 8. Sales data for the articles 3 to be purchased by the customer is registered on the POS terminal 8 in accordance with the data in the wireless tags 4, and the POS terminal 8 calculates a total amount.

The wireless tag reading apparatus 5 uses, as a reading area 9 for the wireless tags 4, the receiving surface 2 and a space of a given length (e.g., 50 cm) in a vertical direction above the receiving surface 2. The antenna 7 transmits an electromagnetic signal toward the reading area 9. Thus, the wireless tag reading apparatus 5 can collectively read the wireless tags 4 of all the articles 3 placed on the receiving surface 2.

An article shelf 10 is placed at the checkout counter 1 in proximity to the reading area 9. The plurality of articles 3 to which the wireless tags 4 are attached are exhibited on the article shelf 10. A plurality of wireless tags 11 are attached to the side plate, which is on the side of the reading area 9, of the article shelf 10 located outside the boundary of the reading area 9. The wireless tags 11 are used to distinguish the outside of the reading area 9 from the inside thereof.

Hereinafter, the wireless tags 11 attached to the article shelf 10 are referred to as outside-area distinguishing wireless tags 11. The wireless tags 4 attached to the articles are referred to as article wireless tags 4.

The outside-area distinguishing wireless tag 11 is the same type as the article wireless tag 4. The data structures of the article wireless tag 4 and the outside-area distinguishing wireless tag 11 are shown in FIG. 2. As shown in FIG. 2, each of the article wireless tag 4 and the outside-area distinguishing wireless tag 11 stores a tag classification code 21 and user data 22. However, the contents of the data are different.

The article wireless tag 4 designates the tag classification code 21 as “001”, and designates the user data 22 as an article ID for identifying each article to which this tag 4 is attached. The outside-area distinguishing wireless tag 11 designates the tag classification code 21 as “101”, and designates the user data 22 as given data. That is, the outside-area distinguishing wireless tag 11 and the article wireless tag 4 are differentiated from each other by the tag classification code 21.

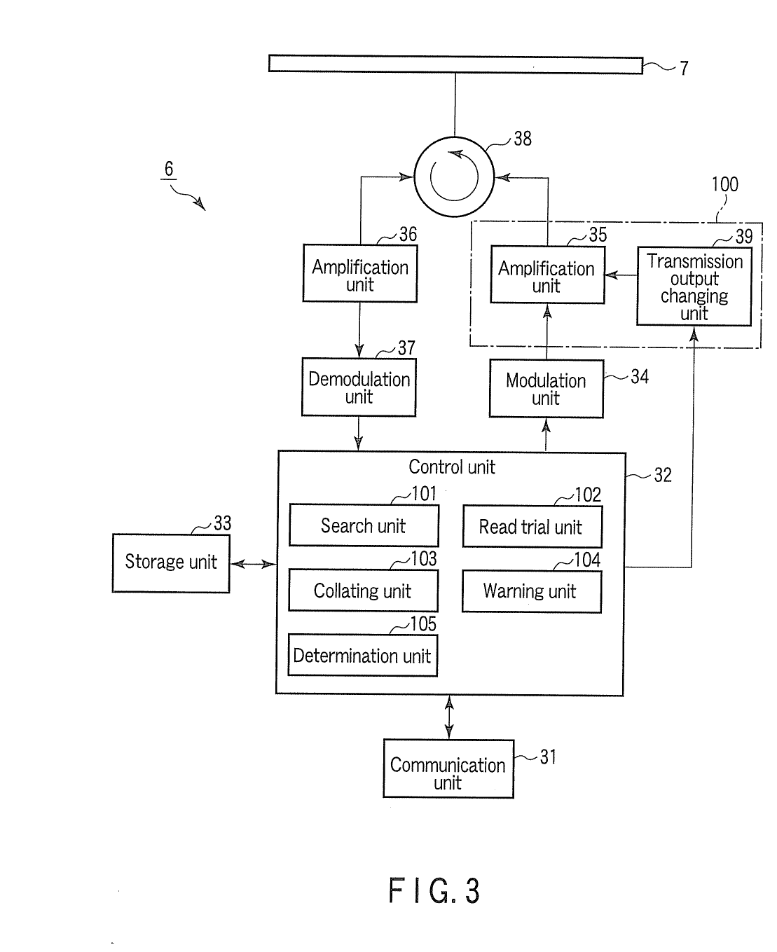

FIG. 3 is a block diagram showing the configuration of the essential parts of the reading apparatus main body 6. The reading apparatus main body 6 comprises a communication unit 31, a control unit 32, a storage unit 33, a modulation unit 34, a transmission side amplification unit 35, a reception side amplification unit 36, a demodulation unit 37, a circulator 38 and a transmission output changing unit 39.

The communication unit 31 enables a data communication between the control unit 32 and the POS terminal 8. The modulation unit 34 modulates a carrier wave with transmission data provided from the control unit 32. The transmission side amplification unit 35 amplifies a signal output from the modulation unit 34. The reception side amplification unit 36 amplifies a signal received by the antenna 7. The demodulation unit 37 demodulates a data signal of the wireless tag from the signal amplified by the reception side amplification unit 36. The circulator 38 supplies the antenna 7 with a signal output from the transmission side amplification unit 35, and supplies the reception side amplification unit 36 with the signal received by the antenna 7.

The transmission output changing unit 39 changes the amplification factor of the transmission side amplification unit 35 step by step. If the amplification factor of the transmission side amplification unit 35 is changed, the output power of the electromagnetic signal transmitted from the antenna 7 changes. Here, the transmission side amplification unit 35 and the transmission output changing unit 39 constitute an output varying unit 100 for changing step by step the transmission output of the electromagnetic signal transmitted from the antenna.

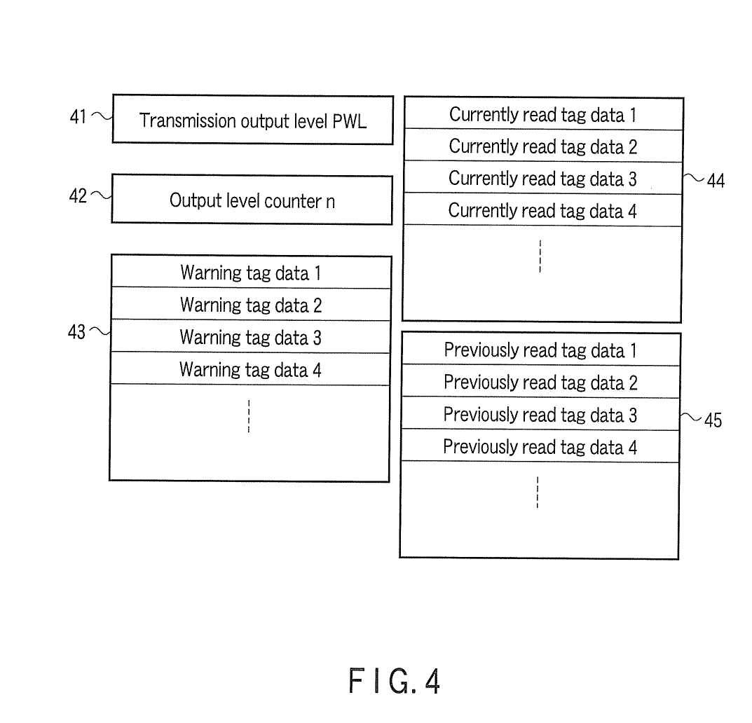

The storage unit 33 includes a plurality of memory areas shown in FIG. 4. A transmission output level memory 41 stores an output power level PWL of the antenna 7 at the present moment. An output level counter memory 42 counts the number of stages n (1≦n≦N) corresponding to the output power level PWL. In the first embodiment, the output power level PWL is at the minimum level when the number of stages n is 1, and the output power level PWL is at the maximum level when the number of stages n is N.

A warning tag memory 43 collectively stores the data in the article wireless tags 4 attached to the articles 3 placed on the article shelf 10 outside the boundary of the reading area 9 (an outside-area article tag storage unit). A current reading memory 44 collectively stores the data in the wireless tags collectively read by the wireless tag reading apparatus 5 in a current wireless tag reading cycle. A previous reading memory 45 collectively stores the data in the wireless tags collectively read by the wireless tag reading apparatus 5 in a previous wireless tag reading cycle.

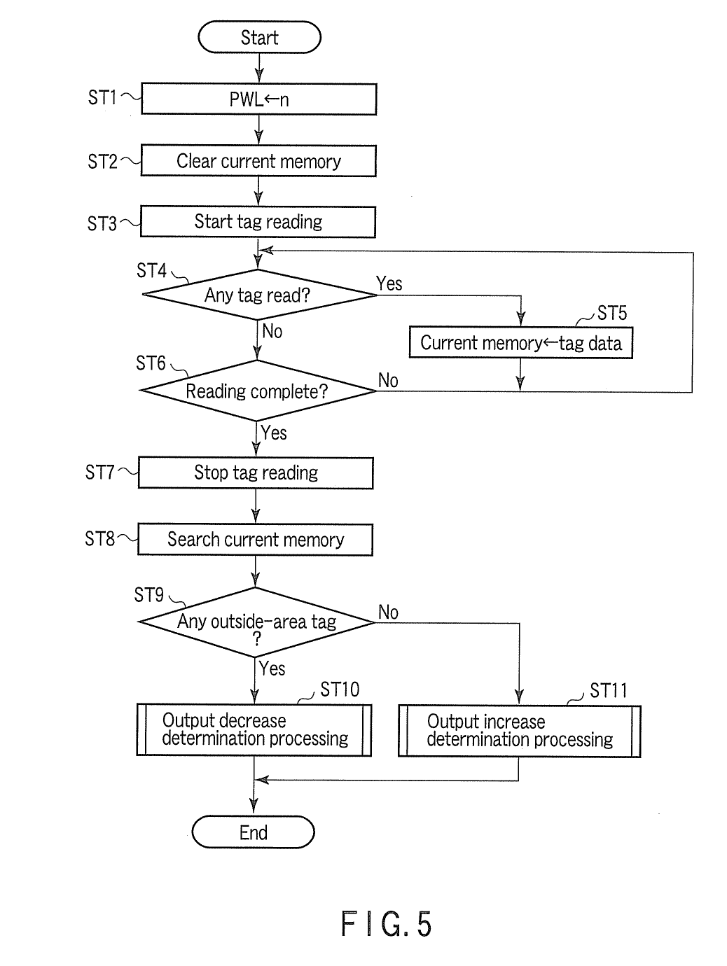

The control unit 32 functions as a search unit 101, a read trial unit 102, a collating unit 103, a warning unit 104 and a determination unit 105. These functions will be sequentially described in the explanation of the flowchart in FIG. 5. If a start command is input from the outside, the control unit 32 starts main processing whose procedure is shown in FIG. 5.

After confirming that the customer has mounted the articles to purchase on the receiving surface 2, the operator of the POS terminal 8 operates the POS terminal 8 to instruct the apparatus to start the reading of the article wireless tag 4. In response to this instruction, the POS terminal 8 activates and outputs a start command to the control unit 32.

Alternatively, an article sensor is provided in the vicinity of the receiving surface 2. The article sensor activates when the customer mounts the articles to purchase on the receiving surface 2, and outputs the start command to the control unit 32.

When the start command is input, the control unit 32 sets the transmission output level memory 41 at a count n of the output level counter memory 42 (ST1). The control unit 32 also clears the current reading memory 44 (ST2).

Then, the control unit 32 starts a wireless tag read operation (ST3). That is, the control unit 32 transmits a read command to the modulation unit 34. The control unit 32 also transmits a transmission output control signal to the transmission output changing unit 39.

On receiving the transmission output control signal, the transmission output changing unit 39 sets the amplification factor of the transmission side amplification unit 35 so that the output power of the electromagnetic signal transmitted from the antenna 7 may be equal to the output power level PWL stored in the transmission output level memory 41. This control sets the amplification factor of the transmission side amplification unit 35 to a value corresponding to the count n of the output level counter memory 42.

On receiving the read command, the modulation unit 34 uses this read command to modulate a carrier wave. After amplified in the transmission side amplification unit 35, the modulated signal is supplied to the antenna 7 via the circulator 38, and transmitted as an electromagnetic signal. The transmission output level at this moment is decided by the amplification factor of the transmission side amplification unit 35.

After recognizing the read command, the wireless tag which has received the electromagnetic signal transmitted from the antenna 7 wirelessly transmits its memory data by, for example, backscatter modulation. When the electromagnetic signal is received by the antenna 7, the received signal is supplied to the reception side amplification unit 36 via the circulator 38. After amplified, the received signal is input to the demodulation unit 37, and demodulated to a data signal of the wireless tag.

The control unit 32 waits for the data signal of the wireless tag to be demodulated (ST4). When the data signal demodulated in the demodulation unit 37 is input (YES in ST4), the control unit 32 stores, in the current reading memory 44, tag data obtained by demodulating the data signal (ST5).

Whenever the demodulated data signal is input, the control unit 32 stores, in the current reading memory 44, tag data obtained from the data signal. Thus, the current reading memory 44 collectively stores the collectively read data in the plurality of wireless tags in one reading cycle.

During this waiting period, the control unit 32 determines whether the reading of the wireless tags is complete (ST6). For example, when a certain period of time has passed since the start of the wireless tag read operation, the control unit 32 determines that the reading is complete. Alternatively, the control unit 32 determines that the reading is complete if the data signal of the wireless tag is not demodulated for a certain period of time.

When determining that the reading is complete (YES in ST6), the control unit 32 stops the wireless tag read operation (ST7).

Then, the control unit 32 searches the current reading memory 44 (ST8). Further, the control unit 32 determines whether the tag data for the outside-area distinguishing wireless tag 11 is stored in the current reading memory 44 (ST9 [search unit 101]).

That is, the control unit 32 checks the classification code of the tag data stored in the current reading memory 44. The classification code of the outside-area distinguishing wireless tag 11 is “101”. If the tag data having the classification code “101” is detected (YES in ST9), the tag data for the outside-area distinguishing wireless tag 11 is stored in the current reading memory 44. In this case, the control unit 32 executes output decrease determination processing (ST10).

If the tag data having the classification code “101” is not detected (NO in ST9), the tag data for the outside-area distinguishing wireless tag 11 is not stored in the current reading memory 44. In this case, the control unit 32 executes output increase determination processing (ST11).

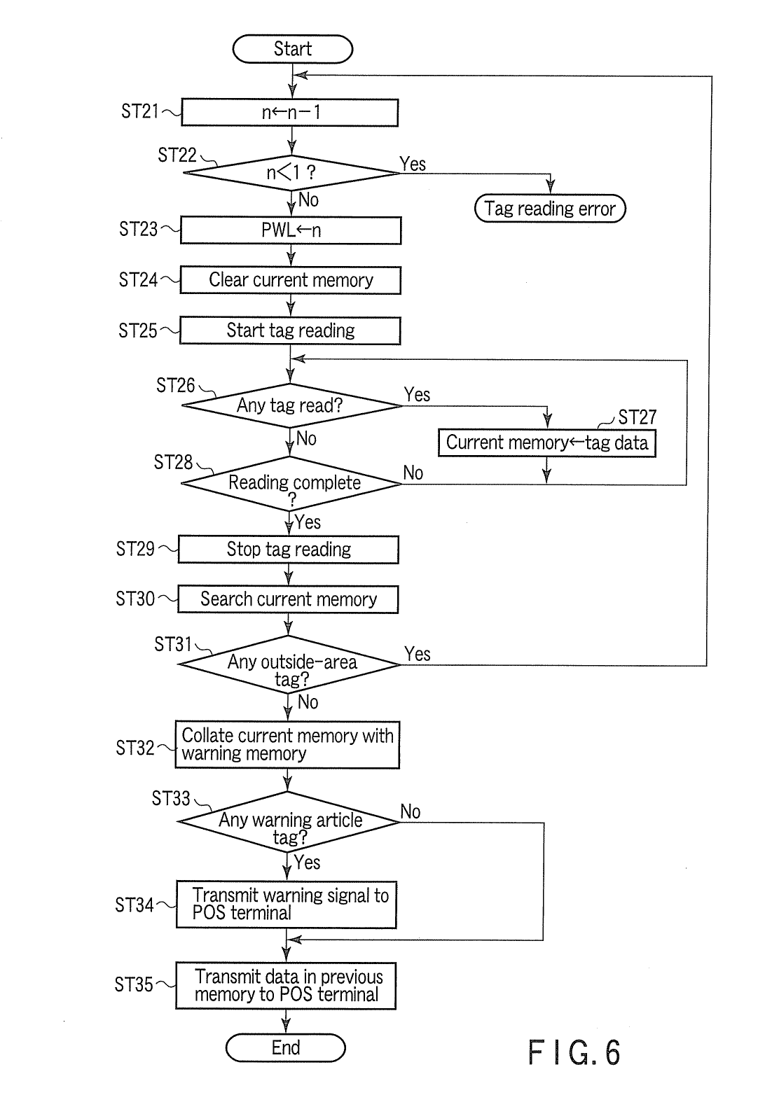

The control procedure of the output decrease determination processing is specifically shown by the flowchart in FIG. 6.

When the output decrease determination processing is started, the control unit 32 subtracts 1 from the count n of the output level counter memory 42 (ST21). Then, the control unit 32 determines whether the count n is less than 1 (ST22).

When the count n is less than 1 (YES in ST22), the control unit 32 reports a tag reading error to the POS terminal 8. On receiving this report, the POS terminal 8 displays an error message stating, for example, “Error in wireless tag reading apparatus”.

When the count n is greater than or equal to 1 (NO in ST22), the control unit 32 again executes, as steps ST23 to ST31, the same processing as that of steps ST1 to ST9.

That is, the control unit 32 sets the transmission output level memory 41 at the count n of the output level counter memory 42 (ST23). The control unit 32 also clears the current reading memory 44 (ST24). Then, the control unit 32 starts a wireless tag read operation (ST25). At the same time, the transmission power of the electromagnetic signal transmitted from the antenna 7 is one level weaker than that at the previous time.

Whenever the data signal demodulated in the demodulation unit 37 is input (YES in ST26), the control unit 32 stores, in the current reading memory 44, tag data obtained by demodulating the data signal (ST27). When the reading is complete (YES in ST28), the control unit 32 stops the wireless tag read operation (ST29).

Then, the control unit 32 searches the current reading memory 44 (ST30), and then determines whether the tag data for the outside-area distinguishing wireless tag 11 is stored (ST31 [search unit 101]).

Here, if the tag data for the outside-area distinguishing wireless tag 11 is still stored (YES in ST31), the control unit 32 returns to the processing in step ST21. That is, the control unit 32 further subtracts 1 from the count n of the output level counter memory 42. If the control unit 32 confirms that the count n is greater than or equal to 1 (NO in ST22), the control unit 32 again executes the processing of steps ST23 to ST31 (read trial unit 102). If it is found out as a result of searching the current reading memory 44 that the tag data for the outside-area distinguishing wireless tag 11 is not stored (NO in ST31), the control unit 32 collates the tag data in the current reading memory 44 with the tag data stored in the warning tag memory 43 (ST32 [collating unit 103]). Then, the control unit 32 checks whether the same tag data as the tag data in the current reading memory 44 is stored in the warning tag memory 43 (ST33).

If the same tag data as the tag data in the current reading memory 44 is stored in the warning tag memory 43 (YES in ST33), the control unit 32 transmits a warning signal to the POS terminal 8 (ST34 [warning unit 104]). If the same tag data as the tag data in the current reading memory 44 is not stored in the warning tag memory 43 (NO in ST33), the control unit 32 does not transmit the warning signal to the POS terminal 8.

The control unit 32 determines the tag data in the current reading memory 44 as data in the article wireless tag 4 present within the reading area 9 (ST35 [determination unit 105]). The determined data in the wireless tag is transmitted to the POS terminal 8. Thus, the current reading processing is complete.

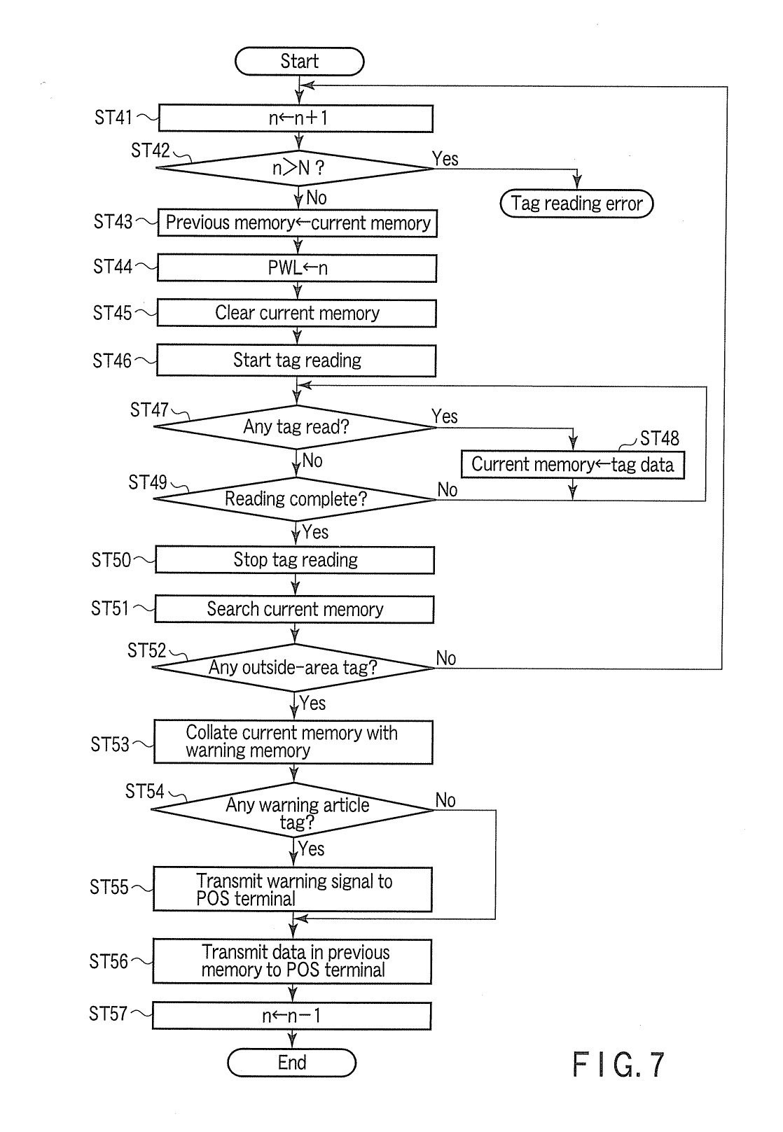

The control procedure of the output increase determination processing is specifically shown by the flowchart in FIG. 7.

When the output increase determination processing is started, the control unit 32 adds 1 to the count n of the output level counter memory 42 (ST41). Then, the control unit 32 determines whether the count n is less than N (ST42).

When the count n is greater than N (YES in ST42), the control unit 32 reports a tag reading error to the POS terminal 8.

When the count n is less than or equal to N (NO in ST42), the control unit 32 copies all the tag data stored in the current reading memory 44 to the previous reading memory 45 (ST43). Subsequently, the control unit 32 again executes, as steps ST44 to ST52, the same processing as that of steps ST1 to ST9.

That is, the control unit 32 sets the transmission output level memory 41 at the count n of the output level counter memory 42 (ST44). The control unit 32 also clears the current reading memory 44 (ST45). Then, the control unit 32 starts a wireless tag read operation (ST46). At the same time, the transmission power of the electromagnetic signal transmitted from the antenna 7 is one level stronger than that at the previous time.

Whenever the data signal demodulated in the demodulation unit 37 is input (YES in ST47), the control unit 32 stores, in the current reading memory 44, tag data obtained by demodulating the data signal (ST48). When the reading is complete (YES in ST49), the control unit 32 stops the wireless tag read operation (ST50).

Then, the control unit 32 searches the current reading memory 44 (ST51), and then determines whether the tag data for the outside-area distinguishing wireless tag 11 is stored (ST52 [search unit 101]).

Here, if the tag data for the outside-area distinguishing wireless tag 11 is still not stored (NO in ST52), the control unit 32 returns to the processing in step ST41. That is, the control unit 32 further adds 1 to the count n of the output level counter memory 42. If the control unit 32 confirms that the count n is less than or equal to N (NO in ST42), the control unit 32 again executes the processing of steps ST43 to ST52 (read trial unit 102).

If it is found out as a result of searching the current reading memory 44 that the tag data for the outside-area distinguishing wireless tag 11 is stored (YES in ST52), the control unit 32 collates the tag data in the previous reading memory 45 with the tag data stored in the warning tag memory 43 (ST53 [collating unit 103]). Then, the control unit 32 checks whether the same tag data as the tag data in the previous reading memory 45 is stored in the warning tag memory 43 (ST54).

If the same tag data as the tag data in the previous reading memory 45 is stored in the warning tag memory 43 (YES in ST54), the control unit 32 transmits a warning signal to the POS terminal 8 (ST55 [warning unit 104]). If the same tag data as the tag data in the previous reading memory 45 is not stored in the warning tag memory 43 (NO in ST54), the control unit 32 does not transmit the warning signal to the POS terminal 8.

The control unit 32 determines the tag data in the previous reading memory 45 as data in the article wireless tag 4 present within the reading area 9 (ST56 [determination unit 105]). The determined data in the wireless tag is transmitted to the POS terminal 8. After completing the transmission, the control unit 32 subtracts 1 from the count of the output level counter memory 42 (ST57). Thus, the current reading control is complete.

In the POS terminal 8 which has received the data in the article wireless tag 4 from the wireless tag reading apparatus 5, an article 3 is specified by the article ID in this data. Then, sales data for this article is registered. Further, the name, price, etc. of this article are indicated on a display. At the same time, a warning message stating, for example, “Surrounding articles may be included in read information” is displayed if a warning signal is received.

The operator of the POS terminal 8 who has confirmed this message checks whether the article corresponding to the indicated name is placed on the receiving surface 2. If this article is not so placed, this article is not to be purchased, so that the operator performs canceling operation. Further, the operator operates a transaction closing key. Then, the total amount of the registered articles is indicated on the display, and the operator thus receives payment from the customer.

As described above, in the first embodiment, the outside-area distinguishing wireless tags 11 differentiable from the article wireless tag 4 are arranged in the vicinity of the outside of the boundary of the reading area 9.

The wireless tag reading apparatus 5 transmits an electromagnetic signal to the reading area 9 from the antenna 7 to read a wireless tag. Then, whenever a wireless tag is read, the wireless tag reading apparatus 5 searches the read wireless tags to find out whether the outside-area distinguishing wireless tags 11 are included therein.

If the outside-area distinguishing wireless tags 11 are included, the reading range is determined to be much greater than the reading area 9. In this case, the wireless tag reading apparatus 5 decreases the transmission power of the electromagnetic signal output from the antenna 7 step by step to retry the read operation. Then, the wireless tag reading apparatus 5 determines, as data in the article wireless tag 4 in the reading area 9, information read at the point where the outside-area distinguishing wireless tag 11 is not included any longer, and transmits the information to the POS terminal 8. That is, information read when no outside-area distinguishing wireless tags 11 are included in the read wireless tags and when the transmission power is maximum is transmitted to the POS terminal 8.

On the other hand, when no outside-area distinguishing wireless tags 11 are included in the read wireless tags, the reading range is determined to be much smaller than the reading area 9. In this case, the wireless tag reading apparatus 5 increases the transmission power of the electromagnetic signal output from the antenna 7 step by step to retry the read operation. Then, the wireless tag reading apparatus 5 determines, as data in the article wireless tag 4 in the reading area 9, information read immediately before the point where the outside-area distinguishing wireless tags 11 are included, and transmits the information to the POS terminal 8. That is, information read when no outside-area distinguishing wireless tags 11 are included in the read wireless tags and when the transmission power is maximum is transmitted to the POS terminal 8.

Therefore, according to the first embodiment, the article wireless tag 4 of the article 3 placed in the reading area 9 can only be accurately read without surrounding the reading area 9 by a mask that does not transmit the electromagnetic signal.

Furthermore, in the first embodiment, data in the article wireless tags 4 attached to some of the articles 3 placed outside the reading area 9 is stored in the warning tag memory 43. When tag data corresponding to the data in the article wireless tag 4 which has been determined as the data in the reading area 9 is present in the warning tag memory 43, a warning is issued to the operator.

Consequently, even if the outside-area distinguishing wireless tags 11 do not respond to the read command and the article wireless tag 4 of the article 3 located outside the boundary of the reading area 9 is included in the determined data, the operator can be notified. Thus, the article wireless tag 4 of the article 3 located outside the boundary of the reading area 9 is not erroneously registered.

### Second Embodiment

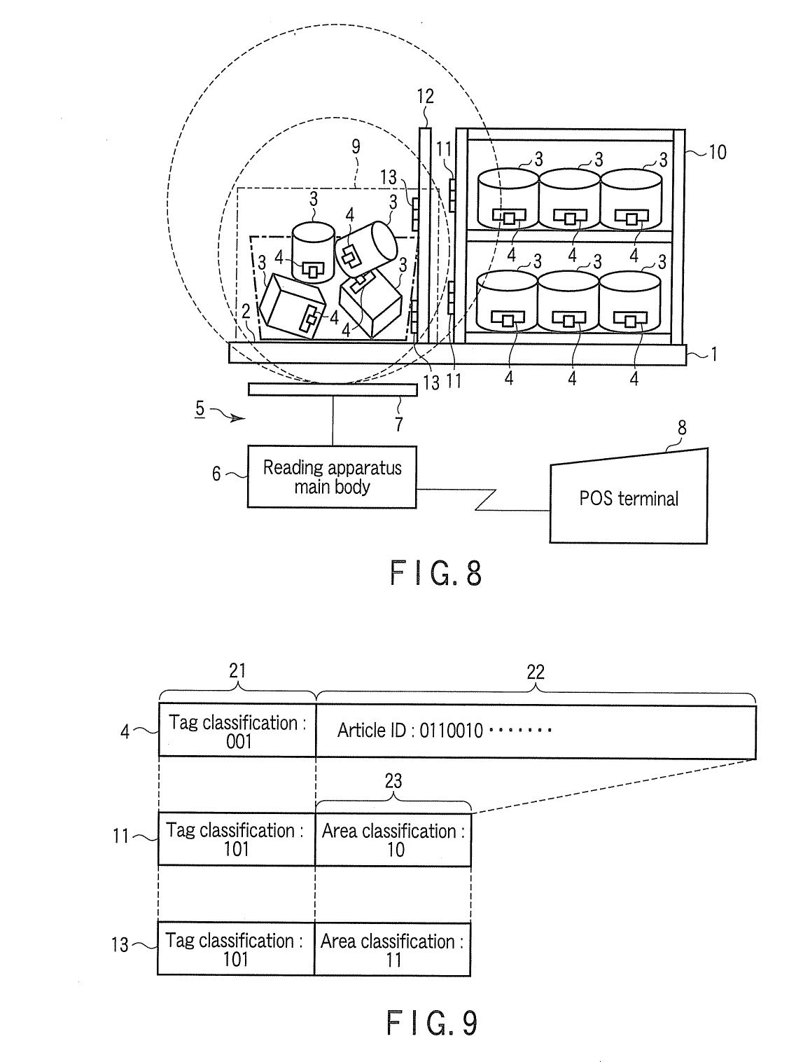

FIG. 8 is a diagram of the entire configuration in a second embodiment. Parts in FIG. 8 similar to the parts in the first embodiment are provided with the same numbers and are not described in detail.

In the second embodiment, a support plate 12 is provided to erect parallel to the side plate of an article shelf 10 in the vicinity of the boundary of a reading area 9 in a checkout counter 1. Further, a plurality of wireless tags 13 are attached to the surface of the support plate 12 opposite to the article shelf 10. The wireless tags 13 are not provided in the vicinity of the boundary of the reading area 9 where outside-area distinguishing wireless tags 11 are arranged, but are provided inside the reading area 9. The wireless tags 13 are used to distinguish the inside of the reading area 9 from the outside thereof, and are referred to as inside-area distinguishing wireless tags 13.

The inside-area distinguishing wireless tag 13 and the outside-area distinguishing wireless tag 11 are the same type as but different in data structure from an article wireless tag 4. The data structures of the article wireless tag 4, the outside-area distinguishing wireless tag 11 and the inside-area distinguishing wireless tag 13 are shown in FIG. 9.

The article wireless tag 4 stores a tag classification code 21 “001”, and user data 22 for an article ID. The outside-area distinguishing wireless tag 11 stores a tag classification code 21 “101”, and an area classification code 23 “10”. The inside-area distinguishing wireless tag 13 stores a tag classification code 21 “101”, and an area classification code 23 “11”.

The area classification code 23 distinguishes the inside and outside of the reading area 9. In the second embodiment, “10” indicates the outside of the area, and “11” indicates the inside of the area. The area classification code 23 has two bits, and has a data length much shorter than the user data 22 for the article ID (e.g., 64 bits).

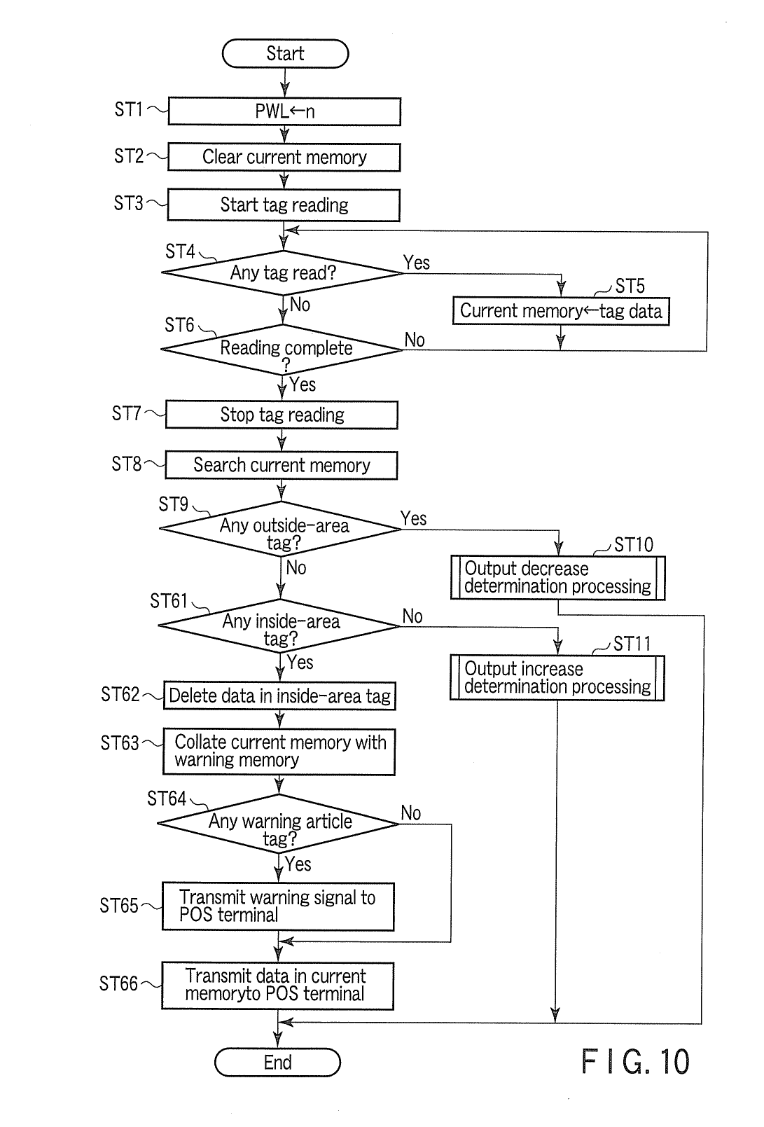

As in the first embodiment, a control unit 32 functions as a search unit 101, a read trial unit 102, a collating unit 103, a warning unit 104 and a determination unit 105. These functions will be sequentially described in the explanation of the flowchart in FIG. 10. If a start command is input from the outside, the control unit 32 starts main processing whose procedure is shown in FIG. 10.

The processing procedure of steps ST1 to ST10 is the same as in the first embodiment. That is, in the first tag read operation (ST1 to ST7), the control unit 32 determines whether tag data for the outside-area distinguishing wireless tag 11 is stored in a current reading memory 44 (ST8, ST9 [search unit 101]). If the tag data is stored (YES in ST9), the control unit 32 performs the above-described output decrease determination processing (ST10 [read trial unit 102]).

If the tag data for the outside-area distinguishing wireless tag 11 is not stored in the current reading memory 44 (NO in ST9), the control unit 32 determines whether tag data for the inside-area distinguishing wireless tag 13 is stored in the current reading memory 44 (ST61 [search unit 101]). If not (NO in ST61), the control unit 32 performs the above-described output increase determination processing (ST11 [read trial unit 102]).

If the tag data for the inside-area distinguishing wireless tag 13 is stored (YES in ST61), the control unit 32 deletes the tag data for the inside-area distinguishing wireless tag 13 from the current reading memory 44 (ST62).

Then, the control unit 32 collates the tag data in the current reading memory 44 with the tag data stored in a warning tag memory 43 (ST63 [collating unit 103]). Further, the control unit 32 checks whether the same tag data as the tag data in the current reading memory 44 is stored in the warning tag memory 43 (ST64).

If the same tag data as the tag data in the current reading memory 44 is stored in the warning tag memory 43 (YES in ST64), the control unit 32 transmits a warning signal to a POS terminal 8 (ST65 [warning unit 104)). If the same tag data as the tag data in the current reading memory 44 is not stored in the warning tag memory 43 (NO in ST64), the control unit 32 does not transmit the warning signal to the POS terminal 8.

The control unit 32 determines the tag data in the current reading memory 44 as data in the article wireless tag 4 present within the reading area 9 (ST66 [determination unit 105]). The determined data in the wireless tag is transmitted to the POS terminal 8. Thus, the current reading control is complete.

As described above, in the second embodiment, the wireless tag reading apparatus 5 transmits an electromagnetic signal to the reading area 9 from the antenna 7 to read the article wireless tag 4. Then, when the outside-area distinguishing wireless tags 11 are not read but the inside-area distinguishing wireless tags 13 are read, the information read in this case is determined as information read from the article wireless tag in the reading area 9. That is, the data in the article wireless tag 4 stored in the current reading memory 44 is determined as information read from the article wireless tag in the reading area 9. The determined data in the current reading memory 44 is transmitted to the POS terminal 8.

Therefore, in this case, there is no need to change the transmission power of the electromagnetic signal to repeat the reading of the article wireless tag 4, so that the time required for the reading processing can be reduced.

In the second embodiment, the value of a transmission output level memory 41 set by the processing in step ST1 is used as a counter value n of an output level counter memory 42. This counter value n corresponds to a transmission output level at which data is determined as information read from the article wireless tag in the reading area 9 in the last reading control. That is, the transmission power at which data is determined as information read from the article wireless tag in the reading area 9 in the last reading control is used as an initial value.

Thus, it is assumed that, in most cases, the outside-area distinguishing wireless tags 11 are not read in the first reading control and the inside-area distinguishing wireless tags 13 are read. As a result, an improvement in reading efficiency can be expected.

Meanwhile, in the second embodiment, the outside-area distinguishing wireless tag 11 and the inside-area distinguishing wireless tag 13 are much smaller in data length than the article wireless tag 4. Thus, the time for reading the outside-area distinguishing wireless tag 11 and the inside-area distinguishing wireless tag 13 is shorter than the time for reading the outside-area distinguishing wireless tag 11 equal in data length to the article wireless tag 4 in the first embodiment. Consequently, even if the inside-area distinguishing wireless tag 13 is newly added, there is no decrease in reading efficiency.

### Third Embodiment

In the first and second embodiments, the data in the article wireless tag 4 to be stored in the warning tag memory 43 is fixed. However, the articles 3 placed in the vicinity of the outside of the boundary of the reading area 9 may vary when purchased by customers or when stock is supplied. Thus, a third embodiment is described next wherein articles 3 placed in the vicinity of the outside of the boundary of a reading area 9 are detected, and data in a warning tag memory 43 is automatically updated in accordance with the result of the detection.

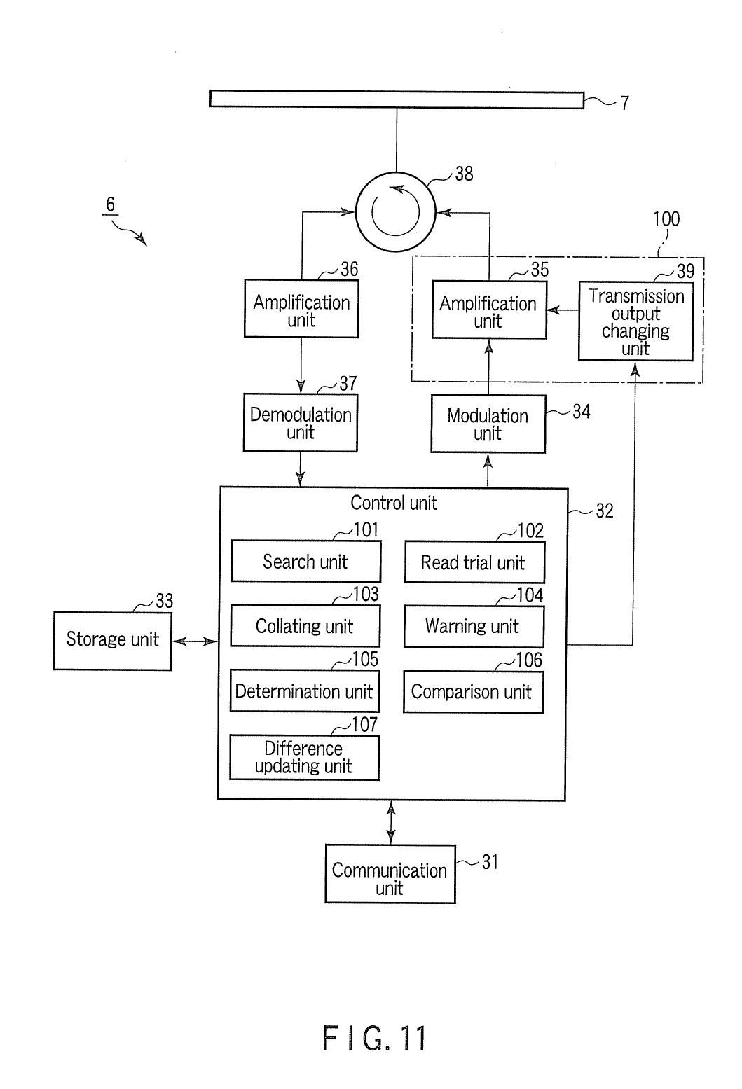

FIG. 11 is a block diagram showing the configuration of the essential parts of a reading apparatus main body 6 in a third embodiment. Parts in FIG. 11 similar to the parts in the first embodiment are provided with the same numbers and are not described in detail.

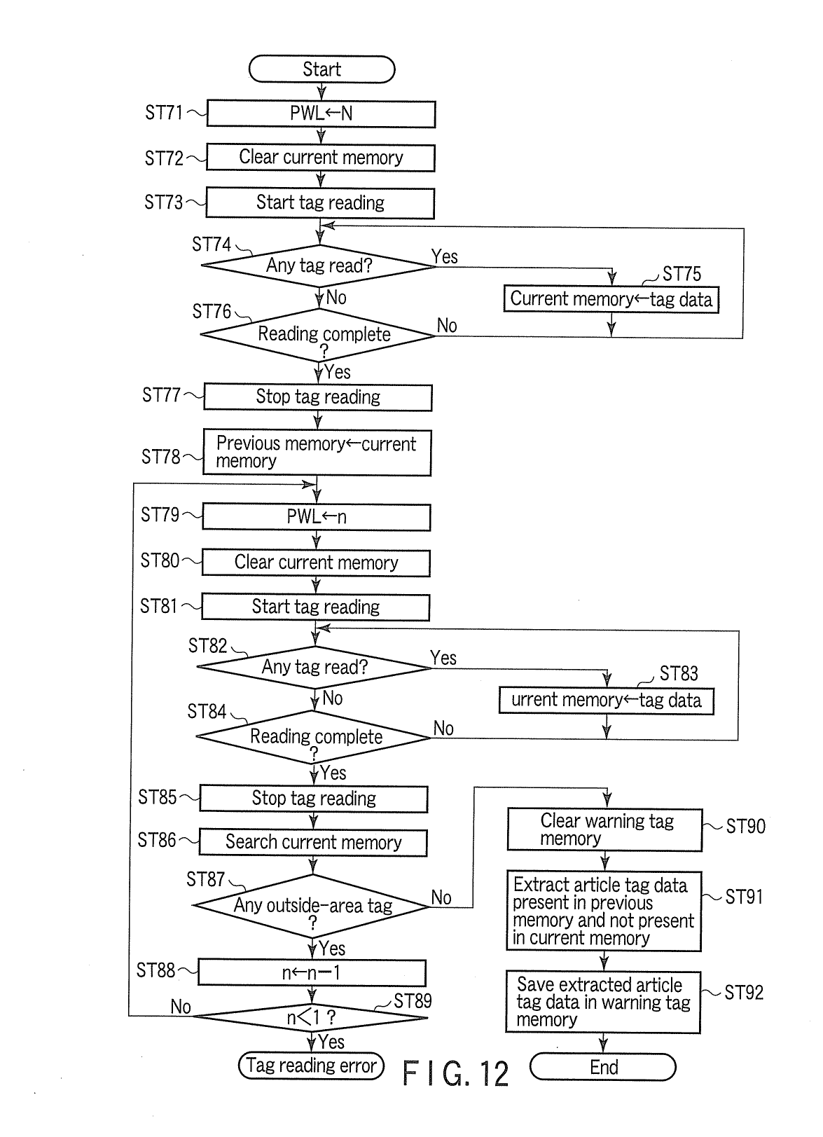

In the third embodiment, a control unit 32 further includes a comparison unit 106 and a difference updating unit 107. These functions will be sequentially described in the explanation of the flowchart in FIG. 12. Whenever the control unit 32 receives, for example, a transaction closing report command which reports that a transaction closing key for declaring the termination of article registration for one transaction has been input from a POS terminal 8, the control unit 32 starts warning tag update processing whose procedure is shown in FIG. 12.

When the transaction closing report command is input, the control unit 32 sets a transmission output level memory 41 at a maximum value N of a transmission output level (ST71). The control unit 32 also clears a current reading memory 44 (ST72).

Then, the control unit 32 starts a wireless tag read operation (ST73). That is, the control unit 32 transmits a read command to a modulation unit 34. The control unit 32 also transmits a transmission output control signal to a transmission output changing unit 39.

On receiving the transmission output control signal, the transmission output changing unit 39 sets the amplification factor of a transmission side amplification unit 35 so that the output power of the electromagnetic signal transmitted from an antenna 7 may be equal to an output power level PWL stored in the transmission output level memory 41. This control sets the amplification factor of the transmission side amplification unit 35 to a value corresponding to the maximum value N of the transmission output level.

On receiving the read command, the modulation unit 34 uses this read command to modulate a carrier wave. After amplified in the transmission side amplification unit 35, the modulated signal is supplied to the antenna 7 via a circulator 38, and transmitted as an electromagnetic signal. The transmission power at this moment is at the maximum level.

After recognizing the read command, the wireless tag which has received the electromagnetic signal transmitted from the antenna 7 wirelessly transmits its memory data by, for example, backscatter modulation. When the electromagnetic signal is received by the antenna 7, the received signal is supplied to a reception side amplification unit 36 via the circulator 38. After amplified, the received signal is input to a demodulation unit 37, and demodulated to a data signal of the wireless tag.

The control unit 32 waits for the data signal of the wireless tag to be demodulated (ST74). When the data signal demodulated in the demodulation unit 37 is input (YES in ST74), the control unit 32 stores, in the current reading memory 44, tag data obtained by demodulating the data signal (ST75).

Whenever the demodulated data signal is input, the control unit 32 stores, in the current reading memory 44, tag data obtained from the data signal. Thus, the current reading memory 44 collectively stores the collectively read data in the plurality of wireless tags in one reading cycle.

During this waiting period, the control unit 32 determines whether the reading of the wireless tags is complete (ST76). When determining that the reading is complete (YES in ST76), the control unit 32 stops the wireless tag read operation (ST77).

The control unit 32 copies all the tag data stored in the current reading memory 44 to a previous reading memory 45 (ST78).

Then, the control unit 32 sets the transmission output level memory 41 at the count n of an output level counter memory 42 (ST79). The count n at this moment corresponds to the transmission power at the point where data is determined as the data in the wireless tags 4 in the reading area 9 in the last reading control.

Subsequently, the control unit 32 executes, as steps ST80 to ST85, the same processing as that of steps ST72 to ST77. That is, the control unit 32 clears the current reading memory 44 (ST80). Further, the control unit 32 starts a wireless tag read operation (ST81).

Whenever the data signal demodulated in the demodulation unit 37 is input (YES in ST82), the control unit 32 stores, in the current reading memory 44, tag data obtained by demodulating the data signal (ST83). When the reading is complete (YES in ST84), the control unit 32 stops the wireless tag read operation (ST85).

Then, the control unit 32 searches the current reading memory 44 (ST86). Further, the control unit 32 determines whether the tag data for an outside-area distinguishing wireless tag 11 is stored in the current reading memory 44 (ST87).

If the tag data for the outside-area distinguishing wireless tag 11 is stored (YES in ST87), the control unit 32 subtracts 1 from the count n of the output level counter memory 42 (ST88). Further, the control unit 32 determines whether the count n of the output level counter memory 42 is greater than or equal to 1 (NO in ST89).

If the count n is greater than or equal to 1 (NO in ST89), the control unit 32 again executes the processing of steps ST79 to ST87. At the same time, the transmission power of the electromagnetic signal transmitted from the antenna 7 is one level weaker than that at the previous time.

If it is found out as a result of searching the current reading memory 44 that the tag data for the outside-area distinguishing wireless tag 11 is not stored (NO in ST87), the control unit 32 clears the warning tag memory 43 (ST90).

Then, the control unit 32 compares the current reading memory 44 with the previous reading memory 45 (ST91 [comparison unit 106]).

The current reading memory 44 stores read information in the case where the outside-area distinguishing wireless tag 11 is not read. The previous reading memory 45 stores read information in the case where the transmission power from the antenna 7 is maximum.

The control unit 32 extracts all the data in the article wireless tags which are stored in the previous reading memory 45 but not stored in the current reading memory 44. Further, the control unit 32 saves all the extracted data in the warning tag memory 43 (ST92 [difference updating unit 107]). Thus, the warning tag update processing is complete.

In step ST91 of this warning tag update processing, the extracted data in the wireless tag is the data in the article wireless tag 4 which can be read when the transmission power is maximum but which cannot be read when the transmission power is dropped to the vicinity of the boundary of the reading area 9. Therefore, the data in the wireless tags attached to the articles 3 placed outside the boundary of the reading area 9 is extracted. Then, the extracted tag data is stored in the warning tag memory 43.

Thus, according to the third embodiment, even if the articles 3 placed outside the boundary of the reading area 9 vary, the data in the wireless tags attached to the articles 3 placed outside the boundary of the reading area 9 can always be stored in the warning tag memory 43.

### Fourth Embodiment

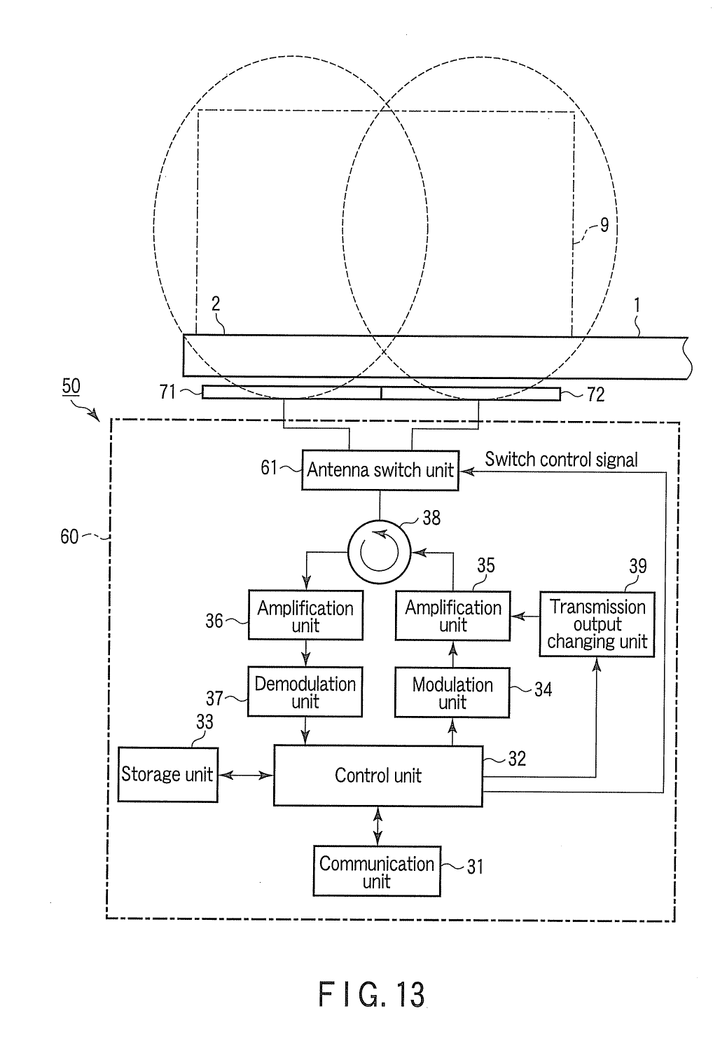

FIG. 13 is a block diagram showing the configuration of the essential parts of a wireless tag reading apparatus 50 in a fourth embodiment. Parts in FIG. 13 similar to the parts in the first embodiment are provided with the same numbers and are not described in detail.

The wireless tag reading apparatus 50 is composed of a reading apparatus main body 60 and a pair of first and second planar antennas 71 and 72. The first antenna 71 and the second antenna 72 are installed side by side immediately under a receiving surface 2 across a checkout counter 1 so that the surfaces of the respective antennas are substantially parallel to a receiving surface 2.

The communication area of the first antenna 71 and the communication area of the second antenna 72 at least partly overlap each other. In addition, the first and second planar antennas 71 and 72 may be attached to the receiving surface 2 of the checkout counter 1 or may be incorporated in the checkout counter 1.

The reading apparatus main body 60 is different from the reading apparatus main body 6 in the first embodiment in that the reading apparatus main body 60 comprises an antenna switch unit 61. The antenna switch unit 61 is provided between a circulator 38 and the antennas 71 and 72. In accordance with a switch control signal from a control unit 32, the antenna switch unit 61 switches between the first antenna 71 and the second antenna 72 to connect to the circulator 38.

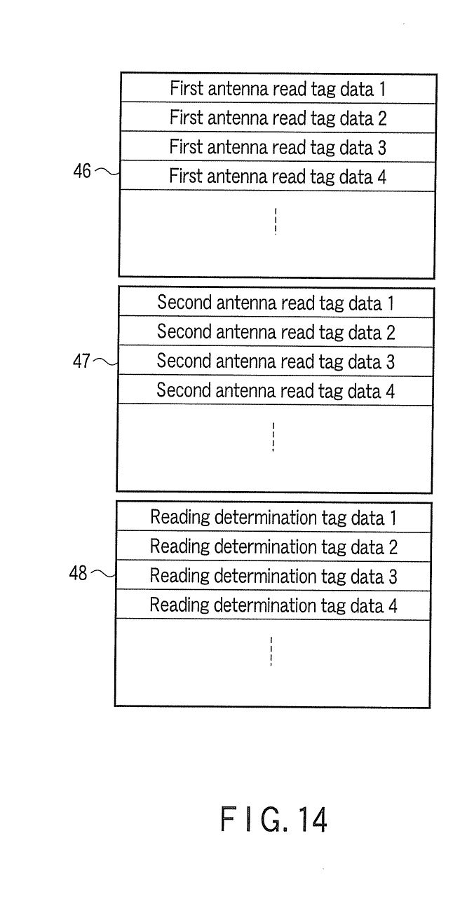

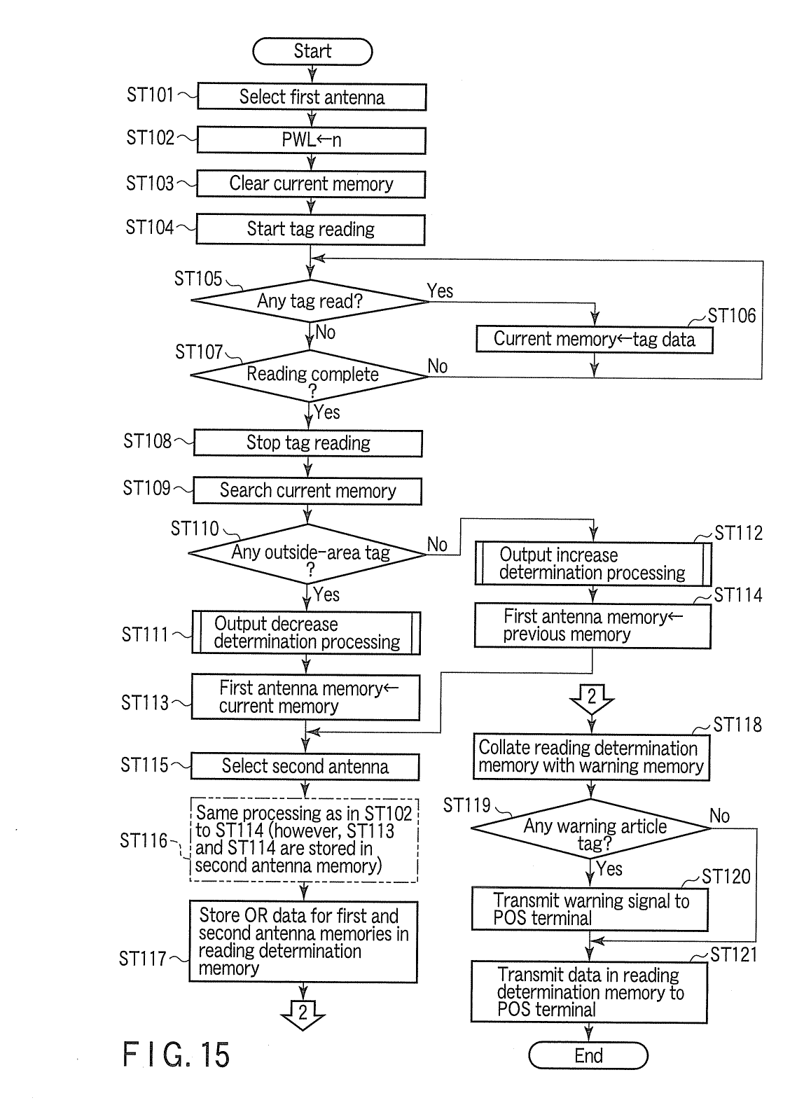

In addition to the memory area shown in FIG. 4, a storage unit 33 further comprises a memory area shown in FIG. 14. That is, the storage unit 33 comprises a first antenna reading memory 46, a second antenna reading memory 47 and a reading determination tag memory 48.

If a start command is input from the outside, the control unit 32 starts main processing whose procedure is shown in FIG. 14. That is, if the start command is input, the control unit 32 outputs, to the antenna switch unit 61, a switch control signal for instructing to select the first antenna 71 (ST101). The antenna switch unit 61 which has received this signal connects the first antenna 71 to the circulator 38.

Then, the control unit 32 executes, as steps ST102 to ST112, the same processing as that of steps ST1 to ST11 in the first embodiment.

That is, the control unit 32 sets a transmission output level memory 41 at the count n of the output level counter memory 42 (ST102). The control unit 32 also clears a current reading memory 44 (ST103).

Then, the control unit 32 starts a wireless tag read operation (ST104). Whenever a data signal demodulated in a demodulation unit 37 is input (YES in ST105), the control unit 32 stores, in the current reading memory 44, tag data obtained by demodulating the data signal (ST106).

When the reading is complete (YES in ST107), the control unit 32 stops the wireless tag read operation (ST108). Then, the control unit 32 searches the current reading memory 44 (ST109), and determines whether the tag data for an outside-area distinguishing wireless tag 11 is stored (ST110 [search unit 101]).

If the tag data for the outside-area distinguishing wireless tag 11 is stored, the control unit 32 executes output decrease determination processing (ST111). If the tag data for the outside-area distinguishing wireless tag 11 is not stored, the control unit 32 executes output increase determination processing (ST112).

When the output decrease determination processing is performed, the tag data stored in the current reading memory 44 is finally determined as the data in the article wireless tag 4 in a reading area 9. Thus, if the output decrease determination processing is complete, the control unit 32 copies the tag data in the current reading memory 44 to the first antenna reading memory 46 (ST113).

Similarly, when the output increase determination processing is performed, the tag data stored in the previous reading memory 45 is finally determined as the data in the article wireless tag 4 in the reading area 9. Thus, if the output increase determination processing is complete, the control unit 32 copies the tag data stored in the previous reading memory 45 to the first antenna reading memory 46 (ST114).

Then, the control unit 32 outputs, to the antenna switch unit 61, a switch control signal for instructing to select the first antenna 71 (ST115). The antenna switch unit 61 which has received this signal connects the second antenna 72 to the circulator 38.

In this condition, the control unit 32 again executes the same processing as that of steps ST102 to ST114 (ST115). However, in ST113, the control unit 32 copies the tag data in the current reading memory 44 to the second antenna reading memory 47. In ST114, the control unit 32 copies the tag data in the previous reading memory 45 to the second antenna reading memory 47.

Then, the control unit 32 stores, in the reading determination tag memory 48, OR data for the tag data in the first antenna reading memory 46 and the tag data in the second antenna reading memory 47 (ST117).

For example, all the tag data in the first antenna reading memory 46 is first stored in the reading determination tag memory 48. Then, tag data which has not yet been stored in the reading determination tag memory 48 is selected from the tag data in the second antenna reading memory 47, and stored in the reading determination tag memory 48.

Alternatively, all the tag data in the second antenna reading memory 47 is stored in the reading determination tag memory 48. Then, tag data which has not yet been stored in the reading determination tag memory 48 is selected from the tag data in the first antenna reading memory 46, and stored in the reading determination tag memory 48.

Then, the control unit 32 collates the tag data in the reading determination tag memory 48 with the tag data stored in a warning tag memory 43 (ST118 [collating unit 103]). Further, the control unit 32 checks whether the same tag data as the tag data in the reading determination tag memory 48 is stored in the warning tag memory 43 (ST119).

If the same tag data is stored (YES in ST119), the control unit 32 transmits a warning signal to a POS terminal 8 (ST120 [warning unit 104). If the same tag data is not stored, the control unit 32 does not transmit the warning signal to the POS terminal 8.

The control unit 32 determines the tag data in the reading determination tag memory 48 as data in the article wireless tag 4 present within the reading area 9 (ST121 [determination unit 105]). The determined data in the wireless tag is transmitted to the POS terminal 8. After completing the transmission, the control unit 32 finishes the current reading control.

According to the fourth embodiment, the advantage is that even when a plurality of antennas are used to expand the reading area 9, the wireless tags of the articles placed in the reading area can only be accurately read without using any particular member such as a mask that does not transmit an electromagnetic signal.

It is to be noted that this invention is not exclusively limited to the embodiments described above and modifications can be made to the components at the stage of carrying out the invention without departing from the spirit thereof.

In the embodiments described above, the transmission power of the antenna 7 is changed step by step to set an optimum reading area where the outside-area distinguishing wireless tags 11 are not detected. In another embodiment, a phase array antenna in which a plurality of antenna elements are arranged may be used as the antenna 7. The gain and phase of each antenna element are properly changed to change the directivity of the antenna, so that an optimum reading area where the outside-area distinguishing wireless tags 11 are not detected can be set.

In the embodiments described above, the outside-area distinguishing wireless tags 11 are provided on the side plate of the article shelf 10. The part where the outside-area distinguishing wireless tags 11 are provided is not particularly limited. The part where the inside-area distinguishing wireless tags 13 are provided is not limited to the support plate 12 either. Moreover, the number of the outside-area distinguishing wireless tags 11 and the number of the inside-area distinguishing wireless tags 13 are not particularly limited either. It is only necessary that the outside-area distinguishing wireless tags 11 differentiable from the article wireless tag 4 be arranged in the vicinity of the outside of the boundary of the reading area 9 and that the inside-area distinguishing wireless tags 13 differentiable from the article wireless tag 4 and the outside-area distinguishing wireless tags 11 be arranged inside the vicinity of the boundary of the reading area 9.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of reading, by a wireless tag reading apparatus, article wireless tags attached to articles placed in a reading area, the method comprising:
disposing an outside-area distinguishing wireless tag differentiable from the article wireless tag outside the boundary of the reading area,
transmitting transmits an electromagnetic signal to the reading area from an antenna of the wireless tag reading apparatus to read the wireless tags,
searching the read wireless tags to find out whether the outside-area distinguishing wireless tag is included therein, and
determining that the reading range is greater than the reading area if the outside-area distinguishing wireless tag is included in the read wireless tags.

2. The wireless tag reading method according to claim 1, further comprising,
decreasing the transmission output level of the electromagnetic signal to again read the wireless tags if the reading range is greater than the reading area.

3. The wireless tag reading method according to claim 2, further comprising,
determining data in the currently read wireless tag if the outside-area distinguishing wireless tag is not included as a result of reading the wireless tags after decreasing the transmission output level of the electromagnetic signal.

4. The wireless tag reading method according to claim 1, further comprising,
determining that the reading range is equal to or smaller than the reading area when the outside-area distinguishing wireless tag is not included in the read wireless tags.

5. The wireless tag reading method according to claim 4, further comprising,
increasing the transmission output level of the electromagnetic signal to again read the wireless tags if the reading range is equal to or smaller than the reading area.

6. The wireless tag reading method according to claim 5, further comprising,
determining data in the currently read wireless tag if the outside-area distinguishing wireless tag is included as a result of reading the wireless tags after increasing the transmission output level of the electromagnetic signal.

7. The wireless tag reading method according to claim 1, further comprising:
disposing an inside-area distinguishing wireless tag differentiable from the outside-area distinguishing wireless tag, the inside-area distinguishing wireless tag being disposed inside the boundary of the reading area,
searching the read wireless tags to find out whether the inside-area distinguishing wireless tag is included therein, and
determining that the reading range is smaller than the reading area when the inside-area distinguishing wireless tag is not included in the read wireless tags.

8. The wireless tag reading method according to claim 7, further comprising,
determining data in the currently read wireless tag if neither the outside-area distinguishing wireless tag is not included in the read wireless tags but the inside-area distinguishing wireless tag is included in the read wireless tags.

9. The wireless tag reading method according to claim 7, further comprising,
decreasing the transmission output level of the electromagnetic signal to again read the wireless tags if the reading range is greater than the reading area, or increasing the transmission output level of the electromagnetic signal to again read the wireless tags if the reading range is smaller than the reading area.

10. The wireless tag reading method according to claim 9, further comprising,
determining data in the currently read wireless tag if the outside-area distinguishing wireless tag is not included in the read wireless tags but the inside-area distinguishing wireless tag is included in the read wireless tags.

11. An apparatus which reads article wireless tags attached to articles, the apparatus comprising:
an antenna which transmits an electromagnetic signal to a reading area for the article wireless tag;
an output varying unit which changes the transmission output of the electromagnetic signal transmitted from the antenna;
a read trial unit which changes the transmission output of the electromagnetic signal to repeat the reading of the article wireless tag;
a search unit which searches the read wireless tags to find out whether an outside-area distinguishing wireless tag is included therein whenever the article wireless tag is read by the read trial unit, the outside-area distinguishing wireless tag being disposed outside the boundary of the reading area and being differentiable from the article wireless tag; and
a determination unit which determines, as information read from the article wireless tag in the reading area, information read if the outside-area distinguishing wireless tag is not included in the read wireless tags and the transmission output of the electromagnetic signal is maximum.

12. The wireless tag reading apparatus according to claim 11, wherein
the read trial unit decreases the transmission, output step by step to again read the article wireless tag if the result of the search by the search unit shows that the outside-area distinguishing wireless tag is included in the read wireless tags.

13. The wireless tag reading apparatus according to claim 12, further comprising:
a current reading memory which stores, whenever the article wireless tag is read by the read trial unit, data in the read wireless tag,
wherein the determination unit determines the data in the current reading memory as data in the article wireless tag in the reading area at the point where the search unit determines that the outside-area distinguishing wireless tag is not included in the read wireless tags.

14. The wireless tag reading apparatus according to claim 11, wherein
the read trial unit increases the transmission output step by step to again read the article wireless tag if the result of the search by the search unit shows that the outside-area distinguishing wireless tag is not included in the read wireless tags.

15. The wireless tag reading apparatus according to claim 14, further comprising:
a current reading memory which stores, whenever the article wireless tag is read by the read trial unit, data in the read wireless tag; and
a previous reading memory which stores the data stored in the current reading memory before a next wireless tag is read by the read trial unit,
wherein the determination unit determines the data in the previous reading memory as information read from the article wireless tag in the reading area at the point where the search unit determines that the outside-area distinguishing wireless tag is included.

16. The wireless tag reading apparatus according to claim 11, further comprising:
an outside-area article tag storage unit which stores data in the wireless tags attached to the articles placed outside the reading area;
a collating unit which performs collation to find out whether data stored in the outside-area article tag storage unit is present in the information read from the article wireless tag determined by the determination unit; and
a warning unit which issues a warning if it is confirmed as a result of the collation by collating unit that the data stored in the outside-area article tag storage unit is present in the information read from the article wireless tag.

17. The wireless tag reading apparatus according to claim 16, further comprising:
a comparison unit which compares information read in case that the outside-area distinguishing wireless tag is included in the read wireless tags with information read in case that the outside-area distinguishing wireless tag is not included in the read wireless tags; and
a difference updating unit which stores, in the outside-area article tag storage unit, data in the article wireless tag, the data in the article wireless tag being included in the information read in case that the outside-area distinguishing wireless tag is included and being not included in the information read in case that the outside-area distinguishing wireless tag is not included.

18. The wireless tag reading apparatus according to claim 11, wherein
the search unit further searches the read wireless tags to find out whether an inside-area distinguishing wireless tag is included therein, the inside-area distinguishing wireless tag being disposed inside the boundary of the reading area and being differentiable from the article wireless tag and the outside-area distinguishing wireless tag.

19. The wireless tag reading apparatus according to claim 18, wherein
the determination unit determines, as information read from the article wireless tag in the reading area, information read if the inside-area distinguishing wireless tag is included in the read wireless tags and the outside-area distinguishing wireless tag is not included.

20. The wireless tag reading apparatus according to claim 11, wherein
a plurality of the antennas are provided,
the read trial unit changes the transmission output of the electromagnetic signal for each of the antennas to repeat the reading of the article wireless tag, and
the determination unit determines, for each of the antennas, information read from the article wireless tag in the reading area, and further determines, as final information read from the article wireless tag in the reading area, a combination of the information read from the article wireless tags determined for the respective antennas.
